(19) United States
(12) Patent Application Publication
(10) Pub. No.: US 2009/0204923 A1
(43) Pub. Date: Aug. 13, 2009

(54) DEVICE SETTING APPARATUS AND DEVICE SETTING SYSTEM

(75) Inventor: Seiichiroh Tachibana, Nara (JP)

Correspondence Address: EDWARDS ANGELL PALMER & DODGE LLP, P.O. BOX 55874, BOSTON, MA, 02205, US

(73) Assignee: SHARP KABUSHIKI KAISHA, Osaka (JP)

(21) Appl. No.: 12/357,667

(22) Filed: Jan. 22, 2009

(30) Foreign Application Priority Data
Feb. 13, 2008 (JP) 2008-031820

(51) Int. Cl. G06F 3/00

(52) U.S. Cl. 715/771

(57) ABSTRACT

The device setting system is formed by connecting an MFP and a PC having a displaying portion over a network. The PC includes a storage portion that has stored thereon information of an instruction manual including description of a method of setup operation for various setup items of the MFP and setting instruction information for each of the various setup items; if various setup items are displayed when the instruction manual is displayed on the displaying portion, the PC additionally displays a setting instruction accepting portion that accepts an instruction for setting the setup items; and if the setting instruction accepting portion accepts an instruction for setting, the PC extracts and transmits the setting instruction information for the setup items to the MFP. The MFP receives the setting instruction information and sets the setup items in the own machine based on the received setting instruction information.

### CROSS-NOTING PARAGRAPH

This Non-provisional application claims priority under 35 U.S.C. §119(a) on Patent Application No. 2008-031820 filed in JAPAN on Feb. 13, 2008, the entire contents of which are hereby incorporated herein by reference.

### FIELD OF THE INVENTION

The present invention relates to a device setting apparatus having a device to be set defined as an information processing apparatus such as multi-function peripheral (MFP) and a device setting system formed by connecting the device to be set and the device setting apparatus.

### BACKGROUND OF THE INVENTION

An information processing apparatus as a product may be provided with an instruction manual in a paper form and, in this case, when a user purchasing the product disposes the product or does not know how to operate, the user actually holds the instruction manual in hand to check the contents. However, the instruction manuals become thicker and bulky as the functions provided in information processing apparatuses (devices) increase. In such a case that no space is left for placing a instruction manual when operating a device, a user must hold the instruction manual in one hand, operate the device while turning pages, and move a line of sight, which is a burden to the user. For some devices, a plurality of thick instruction manuals may exist and it becomes difficult to ensure a storage place for the instruction manuals in such a case.

If an instruction manual is supplied in a form of an electronic file as a CD with a product, a storage place for the instruction manual is easily ensured. In this case, for example, a user causes a personal computer (PC) to read the electronic file of the instruction manual and displays the instruction manual of the purchased product on the display screen to check how to operate the device. However, when the device is actually operated in this method, the contents of the display screen must preliminarily be output on paper, which is a burden to the user.

Japanese Laid-Open Patent Publication No. 2005-115462 discloses a help displaying apparatus connected to an operation target device to display an operation guide for performing subsequent operations when a user touches an operation icon displayed on a displaying portion along with description of details of operation to solve a problem that an operation manual is thickened and becomes bulky. In this configuration, the user must approach the operation target device in order to set up the device.

On the other hand, the present invention relates to a device setting apparatus and a device setting system capable of facilitating setup operations remotely without difficulty such as changing initial setup values or already set setup values of a device necessary for allowing the device to operate.

### SUMMARY OF THE INVENTION

It is the object of the present invention to provide a device setting apparatus and a device setting system capable of certainly performing setup of an operation target device connected over a network exactly and remotely as displayed while referring to a displayed instruction manual.

It is another object of the present invention to provide a device setting system formed by connecting a device to be set and a device setting apparatus having a displaying portion through a network, the device setting apparatus including a storage portion that has stored thereon information of an instruction manual including description of a method of setup operation for various setup items of the device to be set and setting instruction information for each of the various setup items, a display control portion that additionally displays a setting instruction accepting portion if various setup items are displayed when the instruction manual is displayed on the displaying portion, the setting instruction accepting portion accepting an instruction for setting the setup items, and a transmitting portion that extracts and transmits the setting instruction information for the setup items to the device to be set if the setting instruction accepting portion accepts an instruction for setting, the device to be set including a receiving portion that receives the setting instruction information, and a setting portion that sets the setup items in the own machine based on the received setting instruction information.

It is another object of the present invention to provide the device setting system, wherein the device to be set includes a display control portion that displays an execution instruction accepting portion accepting an instruction for actually executing the setting in the setting portion based on the received setting instruction information.

It is another object of the present invention to provide the device setting system, wherein the device setting apparatus transmits authentication information along with the setting instruction information for the setup items to the device to be set, and wherein the device to be set includes an input portion for authentication information to execute the setting in the setting portion in the own machine based on the received setting instruction information when the received authentication information is input from the input portion.

It is another object of the present invention to provide a device setting apparatus having a displaying unit and connected to a device to be set through a network, comprising: a storage portion that has stored thereon information of an instruction manual including description of a method of setup operation for various setup items of the device to be set and setting instruction information for each of the various setup items; a display control portion that additionally displays a setting instruction accepting portion if various setup items are displayed when the instruction manual is displayed on the displaying portion, the setting instruction accepting portion accepting an instruction for setting the setup items; and a transmitting portion that extracts and transmits the setting instruction information for the setup items to the device to be set if the setting instruction accepting portion accepts an instruction for setting.

### BRIEF DESCRIPTION OF THE DRAWINGS

FIG. 1 is a schematic diagram of an exemplary configuration of a device setting system according to one embodiment of the present invention;

FIG. 2 is a plan view of an example of an operating portion of an MFP according to the present invention;

FIG. 3 is a diagram of an example of a screen displayed when setting a setup item of the MFP according to the present invention;

FIG. 4 is a flowchart for explaining an example of a process in a PC 1 and an MFP 2 when a setting of the MFP 2 is remotely set from the PC 1 of FIG. 1;

FIG. 5 is a diagram of a state of the operating portion in the MFP at the time of device setup according to the present invention; and

FIG. 6 is a diagram of a state of the operating portion in the MFP at the time of device setup according to the present invention.

### PREFERRED EMBODIMENTS OF THE INVENTION

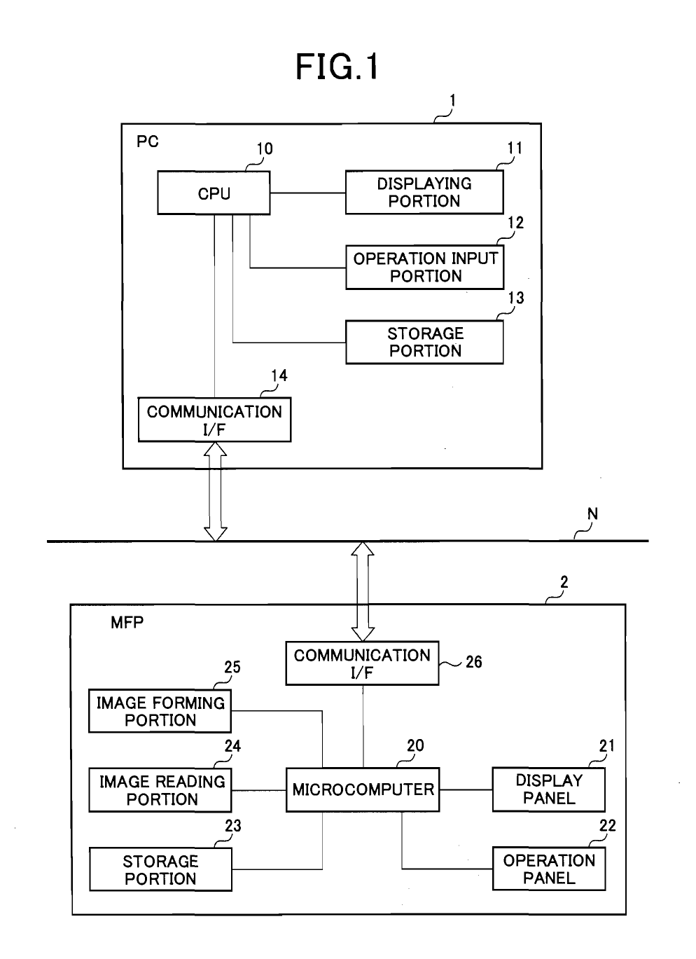

FIG. 1 is a schematic diagram of an exemplary configuration of a device setting system according to one embodiment of the present invention. The device setting system of the present invention is formed by connecting a device to be set and a device setting apparatus that performs setup of the device. The device setting system of the example of FIG. 1 is formed by connecting a personal computer (PC) 1 serving as the device setting apparatus and a digital multi-function peripheral (hereinafter, MFP) 2 serving as the device to be set through a network N such as a LAN (local area network).

The PC 1 includes a CPU 10, a displaying portion 11, an operation input portion 12, a storage portion 13, and a communication I/F 14.

The CPU 10 executes various arithmetic processes and generally controls functions of the PC 1. The displaying portion 11 is an output apparatus for presenting various pieces of information to a user and is made up of a liquid crystal display, for example. The operation input portion 12 is for accepting operations from a user, is made up of input devices such as a keyboard and various pointing devices (e.g., a mouse), and transmits the operations from a user to the CPU 10. The storage portion 13 has various pieces of information stored thereon and is made up of RAM having stored thereon temporal information associated with the arithmetic processes and hard disc, etc., having other pieces of information (e.g., programs) stored thereon. The communication I/F 14 is for the PC 1 transmitting/receiving information to/from the outside, is connectable to the communication network N, and enables information exchange between the PC 1 and the MFP 2 over the communication network N.

The MFP 2 includes a microcomputer 20, a display panel 21, an operation panel 22, a storage portion 23, an image reading portion 24, an image forming portion 25, and a communication I/F 26. The MFP 2 is configured as a multi-function peripheral having functions of a copier and a network scanner device, for example, and includes the microcomputer 20 consisting of a CPU that performs calculations, RAM having stored thereon temporal information associated with the calculations, etc.

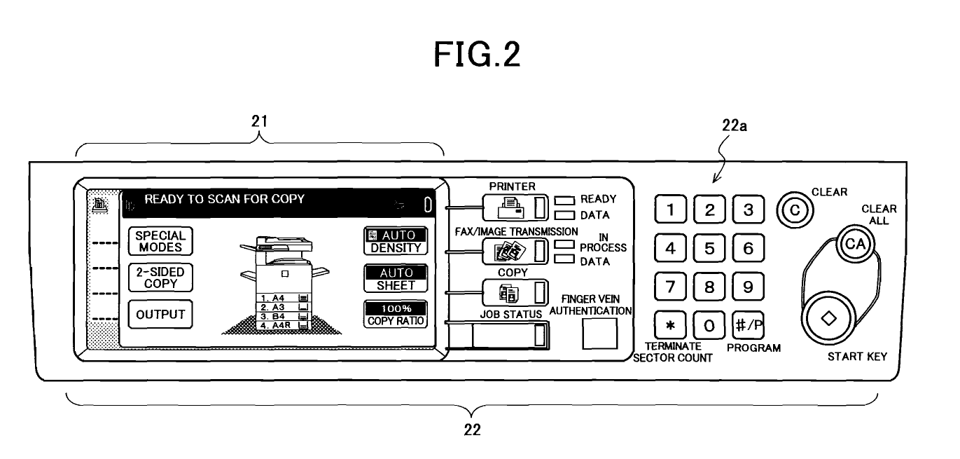

The microcomputer 20 is connected to the display panel 21 and the operation panel 22. The display panel 21 is for presenting various pieces of information to a user and is made up of a liquid crystal panel, for example. The operation panel 22 is for accepting operations from a user and is formed by arranging a plurality of operation input buttons. The display panel 21 and the operation panel 22 make up an operation portion of the MFP 2. FIG. 2 is a plan view of an example of the operating portion of the MFP 2. The operation panel 22 in the operation portion of FIG. 2 has a numeric keypad 22a, a start key, etc. The operation panel 22 includes a transparent touch panel (not shown) overlapping the display panel 21. A user may operate the touch panel to select and operate keys, etc., displayed on the display panel 21. The operation panel 22 transmits operations from a user to the microcomputer 20.

The microcomputer 20 is also connected to the storage portion 23 that has a control program for controlling the MFP 2 stored thereon. The MFP 2 operates in accordance with the setting set by a user or the initial setting and the storage portion 23 has the current setting of the setup items of the MFP 2 stored thereon. The storage portion 23 may have stored thereon the current setting of the setup items for each user.

The microcomputer 20 is also connected to the image reading portion 24 that reads a document image recorded on a recording paper sheet to generate image data, and the image forming portion 25 that forms image data on a recording paper sheet. The MFP 2 may form an image on a recording paper sheet with the image forming portion 25 based on the image data generated by the image reading portion 24. The MFP 2 functions as a copier in this way.

The microcomputer 20 is also connected to the communication I/F 26 for the MFP 2 transmitting/receiving information to/from the outside. The communication I/F 26 is connectable to the communication network N such as an in-house LAN and exchanges information through the communication network N with the PC 1.

The MFP 2 may transmit image data generated by the image reading portion 24 from the communication I/F 26 to the PC 1 based on a process condition set by the PC 1. The MFP 2 functions as a network scanner in this way.

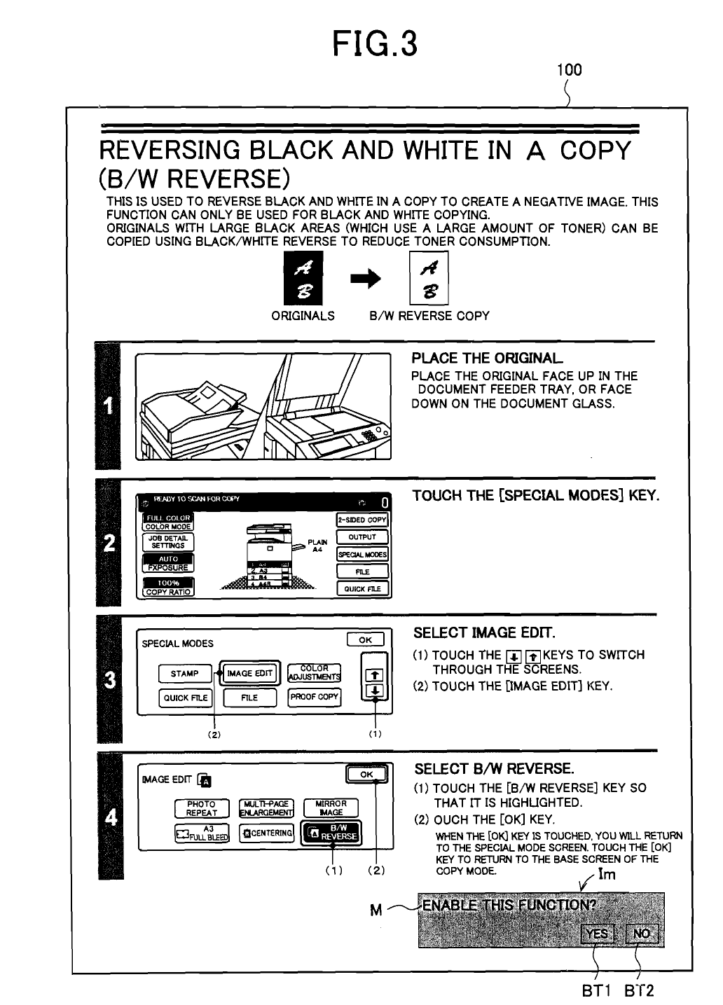

Description will be made of how the setup items of the MFP 2 are set through the PC1 in the device setting system with the above configuration. FIG. 3 is a diagram of an example of a screen displayed when setting a setup item of the MFP according to the present invention.

When the setup items of the MFP 2 are remotely set from the PC 1 that is a terminal apparatus in this device setting system, the CPU 10 of the PC 1 acts as a “display control portion” of the present invention, displays an instruction manual on the displaying portion 11, and if the display is performed for displaying a setup item, a setting instruction accepting portion is also displayed to accept instructions for setting the setup items. A screen 100 of FIG. 3 displayed on the displaying portion 11 is displayed by this display control, displays guide information for a function of the MFP 2 (setup item: “B/W reverse function”) along with a setting instruction acceptance related image Im including a “YES” button BT1 serving as the setting instruction accepting portion. The guide information for the function of the MFP 2 includes the description of the function and the description of a method of setup operation on the MFP 2 for the function.

On the screen 100 the CPU 10 also displays the setting instruction acceptance related image Im including the “YES” button BT1 as well as a message M inquiring whether a displayed setup item is set (“enable this function?”) and a “NO” button BT2. With regard to the “NO” button BT2, for example, if the press-down operation is performed for this button, the CPU 10 terminates the display of the setting instruction acceptance related image Im. The operation of the PC1 at the time of pressing down the “YES” button BT1 will be described later.

In the PC 1, the storage portion 13 serving as a “storage portion” of the present invention has stored thereon information of the instruction manual including description of a method of setup operation on the MFP 2 for various setup items of the MFP 2 (e.g., the same as those provided as a conventional electronic file) and information for displaying the setting instruction acceptance related image to enable the display of the screen 100. The information for displaying the setting instruction acceptance related image includes description of numbers of pages including description of the setup items in the instruction manual (i.e., numbers of the pages where the setting instruction acceptance related images are displayed).

The CPU 10 displays the instruction manual including the guide information of various setup items of the MFP 2 based on information of the instruction manual (hereinafter, instruction manual information). When displaying the instruction manual, the CPU 10 acquires page numbers of the instruction manual currently displayed and may display the setting instruction acceptance related image Im (i.e., the setting instruction accepting portion) along with the guide information for various setup items based on the page numbers and the information for displaying the setting instruction acceptance related image.

A user utilizing this device setting system refers to the guide information for the setup item on the screen 100, checks the currently displayed setup item, and presses down the “YES” button BT1 if the user wishes to set the setup item in the MFP 2. The CPU 10 of the PC 1 detects this press-down operation with the operation input portion 12 to accept the setting instruction for the currently displayed set up item from the user.

The storage portion 13 has stored thereon the setting instruction information for instructing the setting of the setup item for each setup item, and the CPU 10 accepts the setting instruction and extracts the setting instruction information of the setup item displayed on the screen 100 from the stored information. For this extraction, the storage portion 13 has stored thereon the page numbers etc., such that the setup item may be identified at least from the number of the page with the setting instruction acceptance related image Im displayed and, therefore, when accepting the setting instruction, the CPU 10 refers to the storage portion 13 to identify the setup item currently displayed and may extract the setting instruction information of the currently displayed setup item based on the page numbers. The CPU 10 transmits the extracted setting instruction information to the MFP 2 through the communication I/F 14. The CPU 10 functions as a “transmitting portion” of the present invention in this way.

Since a plurality of setup items may be set in some cases, it is preferable that the PC 1 once registers (stores) the currently displayed setup item as the setting desired setup item into the storage portion 13 before the extraction of the setting instruction information to collectively extract the setting instruction information if a plurality of setting desired setup items exists.

For the PC 1 operating as above, the MFP 2 operates as follows. In the MFP 2, the microcomputer 20 functions as a “receiving portion” of the present invention to receive the setting instruction information of the displayed setup item from the PC 1 through the communication I/F 26. If no setting has been performed for a setup item of the MFP 2 displayed on the displaying portion of the PC 1, the microcomputer 20 may set the setup item in the MFP 2 based on the received setting instruction information.

Since the contents (setup items) of the instruction manual displayed on the display screen of the PC 1 may remotely be set in the MFP 2, the user's burden may considerably be alleviated.

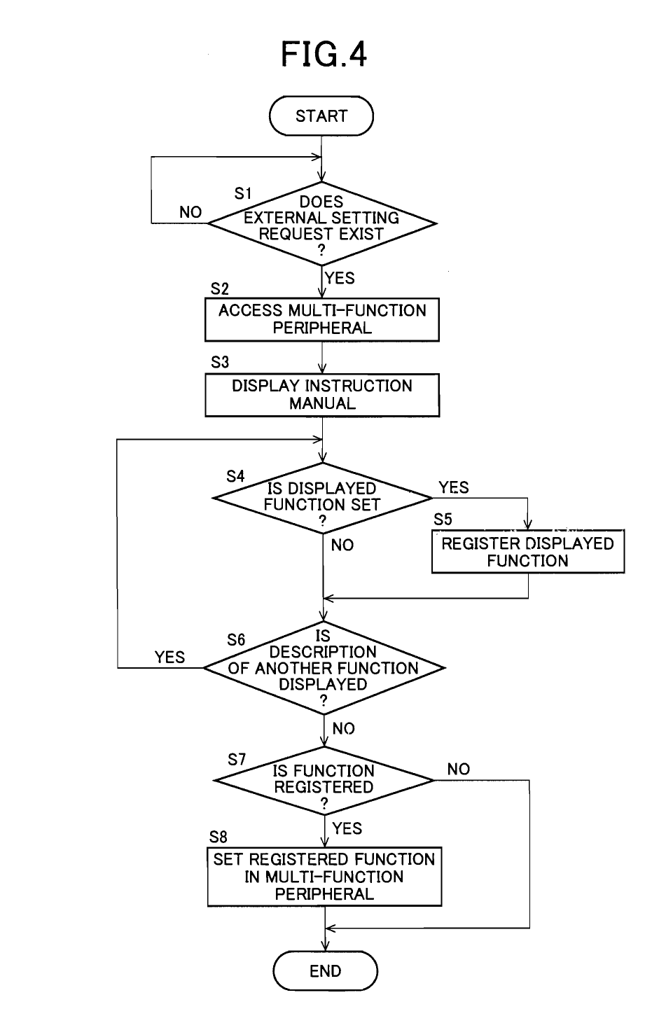

FIG. 4 is a flowchart for explaining an example of a process in the PC 1 and the MFP 2 when a setting of the MFP 2 is remotely set from the PC 1 of FIG. 1.

The PC 1 determines whether a remote setting request (external setting request) from a user exists, for example, based on whether a predetermined application (remote setting application) is activated (step S1). If no remote setting request exists (NO), the process goes back to step S1, and if a remote setting request exists (YES), the PC 1 accesses the MFP 2 through the network N (step S2) to acquire and stores the instruction manual information into the storage portion and the process goes to step S3. If the information for displaying the setting instruction acceptance related image is stored in the MFP 2 and is not retained in the storage portion in advance, the PC 1 acquires the information at step S2. The process of steps S1 and S2 are for acquiring the instruction manual information, the information for displaying the setting instruction acceptance related image, etc., and, therefore, may not be performed if these pieces of information are preliminarily stored in the storage portion 13.

At step S3, the PC 1 displays the instruction manual on the displaying portion 11 based on the instruction manual information and the information for displaying the setting instruction acceptance related image (included in the remote setting application) stored in the storage portion 13 and also displays the setting instruction acceptance related image Im if the display is display of a setup item. Therefore, a user may browse information related to a setup item of the MFP 2 on the display screen of the PC 1 and may press down the “YES” button BT1 to give a setting instruction if it is desirable to set the setup item.

The PC 1 determines whether the setup item of the MFP 2 displayed on the displaying portion 11 (i.e., the “B/W reverse function” or “automatic tray switching function”), based on whether the pressing down of the “YES” button BT1 is detected (step S4).

For example, if the PC 1 detects the pressing down of the “YES” button BT1 on the setting instruction acceptance portion display screen 100 and sets the currently displayed setup item (step S4, YES), the PC 1 refers to the storage portion 13 based on the number of the page currently displayed to identify and registers the currently displayed setup item as a setting desired setup item (step S5), and the process goes to step S6. If the currently displayed setup item is not set at step S4 (NO), th process goes to step S6.

At step S6, the PC 1 determines whether another setup item is displayed through a user's operation. If another setup item is displayed (YES), since the process goes back to step S4 to waits for the press-down operation of the “YES” button BT1 again and the currently displayed setup item is set depending on the result, the device setting system may register a plurality of setup items. The PC may display names of the setup items on the displaying portion 11 so that a user may always check the registered setup items.

If another setup item is not displayed through a user's operation at step S6 (NO), the PC 1 determines whether the setting desired setup item is registered in the storage portion 13 at a predetermined timing (e.g., after the completion of setting instruction is input from a user) (step S7). If not registered (NO), the PC 1 terminates the process through termination of the application, etc., and if registered (YES), the PC 1 extracts the setting instruction information of the registered setup item from the storage portion 13 and transmits the information to the MFP 2 through the communication I/F 14. Before the extraction of the setting instruction information, for example, a list of the registered setup items may be displayed on the displaying portion 11 to allow a user to check the setting contents. The process in the PC 1 is terminated at step S7.

The MFP 2 may receive the setting instruction information to set the registered setup item (the setting desired setup item) in the own machine based on the received setting instruction information. Although the setting instruction information received by the MFP 2 is, for example, a setting program that enables setting of the setup item when executed, the information may take any forms as long as the MFP 2 may set the setup item based on the information.

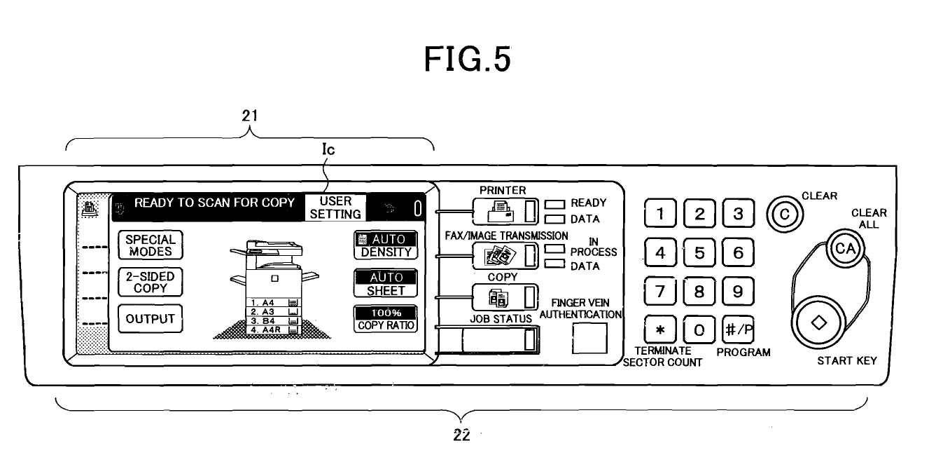

When a device is remotely set as above, another user may be operating the device, and since the operation of another user may be interrupted in the above configuration, it is preferable to configure the device setting system as follows. As shown in FIG. 5, the microcomputer 20 in the MFP 2 acts as the display control portion to display an icon (“user setting”) Ic as an execution instruction accepting portion that accepts from a user an instruction for executing the setting based on the received setting instruction information. When a user's operation to this icon Ic is accepted through the touch panel of the operation panel 22, the user's desired setup item is set in the own machine (MFP 2) based on the received setting instruction information. With this configuration, since the setting of the MFP 2 is not changed until the icon Ic is operated, the operation of another user is not prevented.

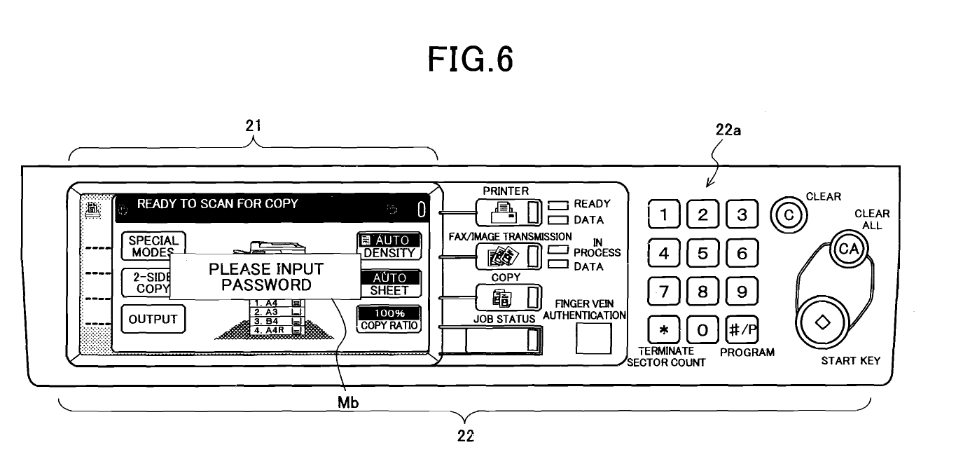

In this case, preferably, the PC 1 transmits authentication information (password) along with the setting instruction information. If the MFP 2 accepts the operation to the icon Ic, the MFP 2 terminates the display of the icon Ic on the display panel 21 and displays a message box Mb including a message that prompts a user to input a password as shown in FIG. 6, and after the password same as the received one is input from the numeric keypad 22a of the operational panel 22, the user's desired setup item is preferably set in the own machine based on the received setting instruction information.

According to the present invention, the following effect may be acquired.

According to the present invention, setup operations may certainly be performed, such as changing initial setup values or already set setup values of a device necessary for allowing the operation target device to operate, while referring to an instruction manual displayed in an apparatus from the apparatus connected to a device to be set through a network.

Therefore, when an operation target device is a copier, setting of copy conditions before coping may be enabled by remote control, and an user may start coping immediately on arriving the copier. Also, when a user supports another user's operation of a copier for inquiries on the operation, setting of copy from a PC nearby may be enabled and the supporter's burden of moving to the copier may be alleviated.

1. A device setting system formed by connecting a device to be set and a device setting apparatus having a displaying portion through a network,
the device setting apparatus including
a storage portion that has stored thereon information of an instruction manual including description of a method of setup operation for various setup items of the device to be set and setting instruction information for each of the various setup items,
a display control portion that additionally displays a setting instruction accepting portion if various setup items are displayed when the instruction manual is displayed on the displaying portion, the setting instruction accepting portion accepting an instruction for setting the setup items, and
a transmitting portion that extracts and transmits the setting instruction information for the setup items to the device to be set if the setting instruction accepting portion accepts an instruction for setting,
the device to be set including
a receiving portion that receives the setting instruction information, and
a setting portion that sets the setup items in the own machine based on the received setting instruction information.

2. The device setting system as defined in claim 1, wherein the device to be set includes a display control portion that displays an execution instruction accepting portion accepting an instruction for actually executing the setting in the setting portion based on the received setting instruction information.

3. The device setting system as defined in claim 2, wherein
the device setting apparatus transmits authentication information along with the setting instruction information for the setup items to the device to be set, and wherein
the device to be set includes an input portion for authentication information to execute the setting in the setting portion in the own machine based on the received setting instruction information when the received authentication information is input from the input portion.

4. A device setting apparatus having a displaying unit and connected to a device to be set through a network, comprising:
a storage portion that has stored thereon information of an instruction manual including description of a method of setup operation for various setup items of the device to be set and setting instruction information for each of the various setup items;
a display control portion that additionally displays a setting instruction accepting portion if various setup items are displayed when the instruction manual is displayed on the displaying portion, the setting instruction accepting portion accepting an instruction for setting the setup items; and
a transmitting portion that extracts and transmits the setting instruction information for the setup items to the device to be set if the setting instruction accepting portion accepts an instruction for setting.
